(19) United States
(12) Patent Application Publication
(10) Pub. No.: US 2015/0175065 A1
(43) Pub. Date: Jun. 25, 2015

(54) CUP HOLDER

(71) Applicant: Hyundai Motor Company, Seoul (KR)

(72) Inventors: Man Ju OH, Yongin-si (KR); Jae Woong KIM, Hwaseong-si (KR); Jae Woo PARK, Ansan-si (KR); Jae Dong YOON, Seoul (KR)

(73) Assignee: Hyundai Motor Company, Seoul (KR)

(21) Appl. No.: 14/294,988

(22) Filed: Jun. 3, 2014

(30) Foreign Application Priority Data
Dec. 19, 2013 (KR) 10-2013-0159546

(51) Int. Cl. B60Q 3/02; F21V 5/00; B60N 3/10; F21V 33/00

(52) U.S. Cl. CPC B60Q 3/0286; F21V 33/00; F21V 5/002; B60N 3/10

(57) ABSTRACT

A cup holder may include a holder body formed in a cylindrical shape, having an opened upper surface and having an installing space formed on an inner peripheral surface of the holder body and protruded from an inner side to an outer side, a lighting apparatus provided in the installing space of the holder body to thereby irradiate light toward an interior of the holder body, and a supporting mechanism elastically and rotatably installed in the installing space of the holder body to thereby support a beverage container received in the holder body and allowing light irradiated from the lighting apparatus to be directed to a bottom surface of the holder body.

### CROSS REFERENCE TO RELATED APPLICATION

The present application claims priority of Korean Patent Application 10-2013-0159546 filed on Dec. 19, 2013, the entire contents of which application are incorporated herein for all purposes by this reference.

### BACKGROUND OF INVENTION

1. Field of Invention

The present invention relates to a cup holder for a vehicle, and more particularly, to a cup holder capable of improving convenience by installing a lighting apparatus in the cup holder to thereby allow a passenger to accurately detect a location of the cup holder even at night and improving aesthetics through light emitting of the cup holder.

2. Description of Related Art

Recently, various equipments for convenience taking into account convenience of a passenger are installed in an interior of a vehicle. As one of various equipments of convenience, a cup holder is provided in the vehicle, wherein the cup holder generally has only a function simply grasping a beverage container.

In general, the cup holder is conveniently installed within the passenger's reach adjacent to a driver's seat and a passenger seat and is installed at various locations depending on a model of the vehicle. The location of the cup holder mentioned above may be detected to easily hold the beverage container because visibility is secured in the daytime, but it is difficult to accurately position the beverage container in the cup holder because the location of the cup holder is not detected at night.

According to the related art, in order to detect the position of the cup holder even at night, a lighting apparatus has been installed in the cup holder to facilitate the detection of the position of the cup holder.

According to most of the related arts, however, a light emitting unit is installed at an opening circumference, wherein, since an optical pipe is used as the light emitting unit, manufacturing cost may be increased.

In addition, the light emitting unit is installed at the circumference of the cup holder to allow the location of the cup holder to be detected, but excessive light may interfere with a driver's drive and excessive installation of the light emitting unit may injure the beauty.

KR10-2012-0118930 A, which is the related art, discloses “Cup Holder Structure of Consol Box”. Also, in a case of the related art mentioned above, since an optical fiber lighting apparatus is used as the light emitting unit in order to illuminate the cup holder, manufacturing cost is increased, the lighting apparatus is simply installed to easily detect the position of the cup holder, and there are no particular characteristics in supporting the beverage container, which is a basic function of the cup holder.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide a cup holder capable of easily detecting a position of the cup holder in a case of night at which it is difficult to secure visibility, solving a dazzle of a driver due to excessive lighting, and implementing luxuriousness of the lighting to thereby improve marketability.

According to various aspects of the present invention, there is provided a cup holder, including: a holder body formed in a cylindrical shape, having an opened upper surface and having an installing space formed on an inner peripheral surface of the holder body and protruded from an inner side to an outer side, a lighting apparatus provided in the installing space of the holder body to thereby irradiate light toward an interior of the holder body, and a supporting mechanism elastically and rotatably installed in the installing space of the holder body to thereby support a beverage container received in the holder body and allowing light irradiated from the lighting apparatus to be directed to a bottom surface of the holder body.

The supporting mechanism may be formed to be rotatably installed at an upper end of the installing space of the holder body, inclined downwardly and extended from the upper end of the installing space to the interior of the holder body, and then bent and extended to a lower end of the installing space. The supporting mechanism may include an upper surface portion that refracts and/or scatters the light irradiated from the lighting apparatus and a lower surface portion that transmits the light irradiated from the lighting apparatus.

The upper surface portion of the supporting mechanism may be opaque or semi-transparent, and the lower surface portion may be transparent and has higher transmissivity of light than the upper surface portion. The upper surface portion of the supporting mechanism may be provided with embossed patterns to thereby scatter the light.

The upper surface portion of the supporting mechanism may be provided with a light reflecting unit disposed on an end surface facing the lighting apparatus to reflect the light irradiated from the light apparatus and direct the reflected light toward the bottom surface of the holder body.

The lower surface portion of the supporting mechanism may be provided with the lighting apparatus installed on an end surface of an installing space side of the holder body and the lighting apparatus may be installed to irradiate the light and direct the irradiated light toward the light reflecting unit provided on the upper surface portion.

The upper surface portion of the supporting mechanism may be provided with an installing part extended to an installing space side of the holder body and the lighting apparatus may be installed on the installing part to irradiate the light to the bottom surface of the holder body.

A plurality of mechanisms may be formed at a circumference of the inner peripheral surface of the holder body. The lighting apparatus may include a light emitting diode (LED) lamp capable of emitting light in different colors. The installing space of the holder body may be provided with a ventilation opening to dissipate heat generated by the lighting apparatus.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are views showing an exemplary cup holder according to the present invention;

FIGS. 3 and 4 are cross-sectional views showing operating states of an exemplary cup holder according to the present invention;

FIGS. 5 and 6 are top views showing operating states of the cup holder shown in FIG. 3; and

FIGS. 7 to 10 are views showing exemplary cup holders according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

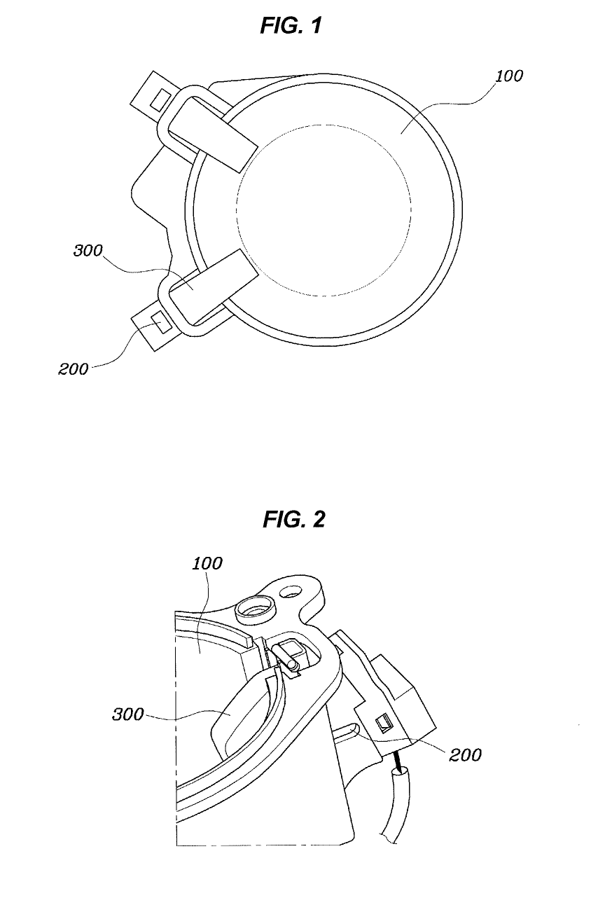

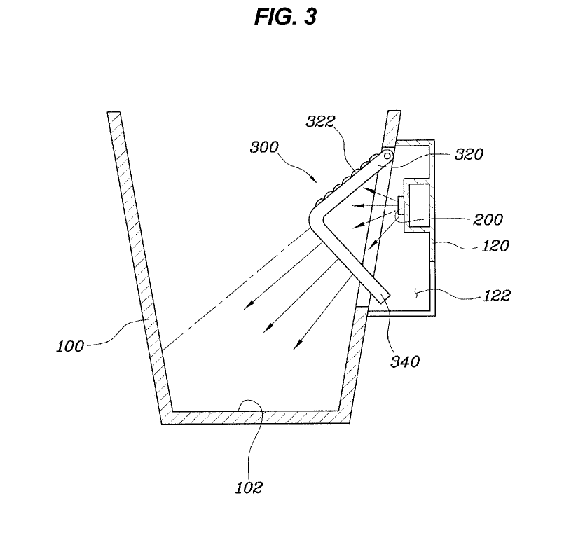

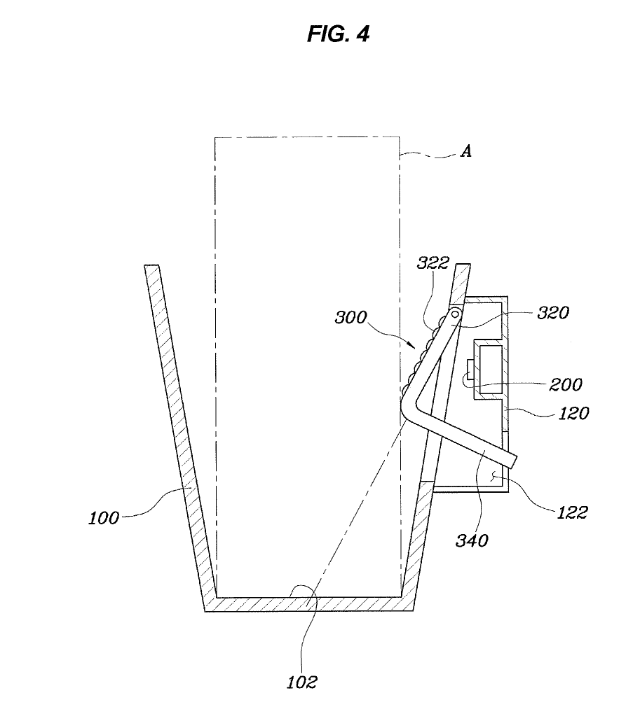

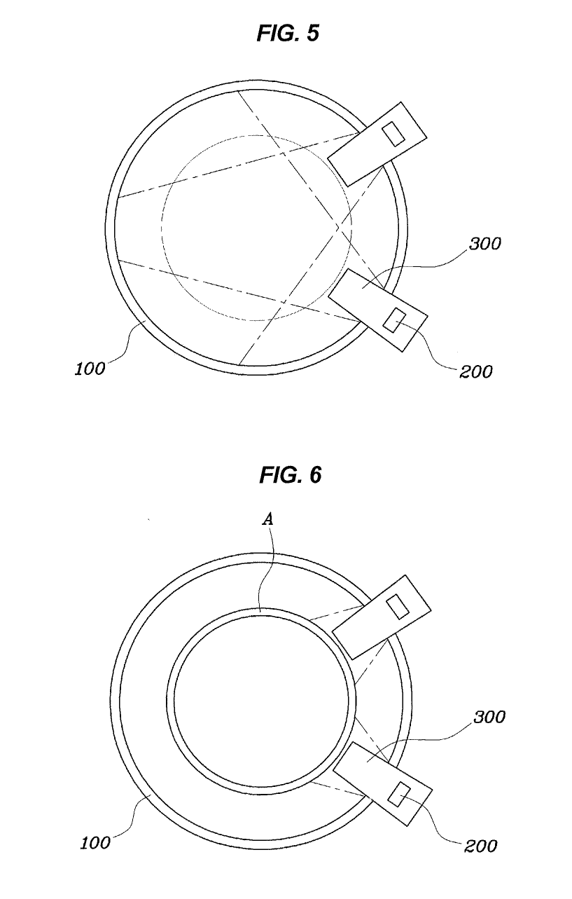

FIGS. 1 and 2 are views showing a cup holder according to various embodiments of the present invention, FIGS. 3 and 4 are cross-sectional views showing operating states of the cup holder according to various embodiments of the present invention, and FIGS. 5 and 6 are top views showing operating states of the cup holder shown in FIG. 3. A cup holder according to various embodiments of the present invention as shown in the above drawings may include a holder body 100 formed in a cylindrical shape having an opened upper surface and having an installing space 120 formed on an inner peripheral surface so as to be protruded from an inner side to an outer side; a lighting apparatus 200 provided in the installing space of the holder body 100 to thereby irradiate light toward an interior of the holder body 100; and a supporting mechanism 300 elastically and rotatably installed in the installing space 120 of the holder body 100 to thereby support a beverage container received in the holder body 100 and allowing light irradiated from the lighting apparatus 200 to be irradiated to a bottom surface 102 of the holder body 100.

Here, the holder body 100 may be formed in the cylindrical shape having the opened upper surface capable of receiving the beverage container A and may be divided into a plurality of regions to receive a plurality of beverage containers. The above-mentioned holder body 100 may be provided with the installing space 120 in which the lighting apparatus 200 and the supporting mechanism 300 are installed.

In addition, a plurality of supporting mechanisms 300 may be formed at a circumference of the inner peripheral surface of the holder body 100, thereby making it possible to more stably support the beverage container A received in the holder body 100 and also increase lighting effect.

The lighting apparatus 200 provided in the installing space 120 of the holder body 100 is installed so as to irradiate light from the installing space 120 of the holder body 100 toward an interior of the holder body 100, thereby allowing a user to easily detect a position of the holder body 100 even at night. The lighting apparatus 200 may use a light emitting diode (LED) lamp capable of expressing various colors or emitting lights in various different colors, thereby emitting light in one or more different colors following a user's preference.

Here, the lighting apparatus 200 is installed so as to irradiate light to the bottom surface 102 of the interior of the holder body 100. As such, by installing the lighting apparatus 200 so as to irradiate light to the interior of the holder body 100, an indirect lighting reflected from the interior of the holder body 100 is formed, thereby making it possible to prevent dazzle from being generated due to light emitted from the lighting apparatus 200, which is then directly delivered to the user. Further, the user may more accurately recognize the position of the holder body 100.

Meanwhile, the supporting mechanism 300 is elastically and rotatably installed in the installing space 120 of the holder body 100, thereby supporting the beverage container A received in the holder body 100. Here, the supporting mechanism 300 may be elastically and rotatably installed in the installing space 120 using a hinge structure and a spring.

When the beverage container A is received in the holder body 100, the supporting mechanism 300 is rotated by compression by the beverage container A and contacts a side surface of the beverage container A received in the holder body 100 so as to elastically support the beverage container A, thereby fixing the beverage container A.

Further, the supporting mechanism 300 allows light irradiated from the lighting apparatus 200 to be irradiated to the bottom surface 102 of the holder body 100 and is rotated depending on an insertion of the beverage container A to allow light emitted from the lighting apparatus 200 to be irradiated to the bottom surface 102 of the holder body 100, thereby making it possible to easily detect the position of the received beverage container.

That is, referring to the cup holder according to various embodiments of the present invention as shown in FIGS. 3 to 6, the supporting mechanism 300 is elastically and rotatably installed at an upper end of the installing space 120 of the holder body 100 and the lighting apparatus 200 is installed at an inner side of the installing space 120 so as to irradiate light to the interior of the holder body 100.

Here, the installing space 120 of the holder body 100 is provided with a ventilation opening 122 to allow heat generated by the light emitting of the lighting apparatus 200 to be discharged, thereby making it possible to secure durability of the lighting apparatus 200 by heat radiation effect. Moreover, a space in which the supporting mechanism 300 may be sufficiently rotated may be secured by the ventilation opening 122 formed in the holder body 100.

Next, the supporting mechanism 300 may be formed of a material capable of transmitting light and is configured so that light emitted from the lighting apparatus 200 transmits through the supporting mechanism 300 to thereby be irradiated to the interior of the holder body 100.

In the case in which it is difficult to detect the position of the cup holder at night, the lighting apparatus 200 is operated to emit light and light emitted from the lighting apparatus 200 penetrates through the supporting mechanism 300 in the installing space 120 of the holder body 100 and is irradiated to the interior of the holder body 100.

Thereby, light reflected from the inner peripheral surface of the holder body 100 is emitted to the opened upper surface of the holder body 100. As such, the position of the holder body 100 is exposed by the indirect lighting, such that the user may accurately detect the position of the holder body 100 without being dazzled.

In this state, when the beverage container A is inserted into the holder body 100, the supporting mechanism 300 is rotated by the beverage container A and elastically contacts the side surface of the inserted beverage container A, thereby fixing the beverage container A received in the holder body 100.

Further, light emitted from the lighting apparatus 200 is reflected from the beverage container received in the holder body 100 and is traveled to an upper surface and a lower surface of the holder body 100. Using this reflected light, the position of the beverage container A received in the holder body 100 is exposed, thereby making it possible to allow the user to easily detect the position of the beverage container.

Specifically describing the supporting mechanism, the supporting mechanism 300 may be formed so as to be rotatably installed at the upper end of the installing space 120 of the holder body 100, be inclined downwardly extended from the upper end of the installing space 120 to the interior of the holder body 100, and be then again bent and extended to a lower end of the installing space 120.

As shown in FIG. 3, by forming the supporting mechanism 300 so as to be extended from the installing space 120 to the inner side of the holder body 100 and again be then bent and extended to the interior of the installing space 120, a radius of rotation of the supporting mechanism 300 according to the insertion of the beverage container A may be decreased. Thereby, a spare space which needs to be secured to rotate the supporting mechanism 300 is decreased, such that a layout may be advantageously performed.

In addition, the present invention is to allow light emitted from the lighting apparatus 200 to be irradiated on the bottom surface 102 of the holder body 100 to thereby expose the position of the holder body 100 by the indirect lighting. To this end, the supporting mechanism 300 is configured so as to block light directly emitted from the lighting apparatus 200 to the upper surface of the holder body 100 and allow light emitted to the interior of the holder body 100. A detailed description thereof will be provided below.

In order to assist in the understanding of the present invention, a portion in which the supporting mechanism 300 is rotatably installed at the upper end of the installing space 120 of the holder body 100 and is inclined downwardly extended from the upper end of the installing space 120 to the interior of the holder body 100 is referred to as an upper surface portion 320 and a portion in which the supporting mechanism 300 is bent at an end of the upper surface portion 320 and is again extended to the lower end of the installing space 120 is referred to as a lower surface portion 340.

The upper surface portion 320 of the supporting mechanism 300 according to various embodiments of the present invention may be formed so that light irradiated from the lighting apparatus 200 is refracted and scattered, and the lower surface portion 340 thereof may be formed so that light irradiated from the lighting apparatus 200 is transmitted as it is.

In addition, the upper surface portion 320 of the supporting mechanism 300 may be opaquely or semi-transparently formed and the lower surface portion 340 may be transparently formed so as to have transmissivity of light higher than the upper surface portion 320.

The present invention blocks light emitted from the lighting apparatus 200 from being directly irradiated to the upper surface of the holder body 100 and allows light to be emitted to the interior of the holder body 100, thereby implementing the indirect lighting.

To this end, the supporting mechanism 300 according to various embodiments of the present invention is formed of the material capable of transmitting light and the upper surface portion 320 thereof is opaquely or semi-transparently formed to thereby transmit light emitted from the lighting apparatus 200, which is refracted or scattered. As a result, light emitted from the lighting apparatus 200 is not irradiated to the upper surface of the holder body 100 as it is, thereby making it possible to prevent the user's dazzle from being generated.

Here, the upper surface portion 320 of the supporting mechanism 300 is provided with embossed patterns 322, thereby making it possible to scatter the transmitted light.

On the contrary, the lower surface portion 340 of the supporting mechanism 300 is transparently formed so as to have transmissivity of light higher than the upper surface portion 320 thereof, such that light emitted from the lighting apparatus 200 is irradiated to the interior of the holder body 100 as it is and light reflected from the interior of the holder body 100 is irradiated to the upper surface, thereby making it possible to improve aesthetics through the indirect lighting and to prevent the user's dazzle from being generated.

Hereinafter, various exemplary embodiments of the present invention will be described with reference to the drawings.

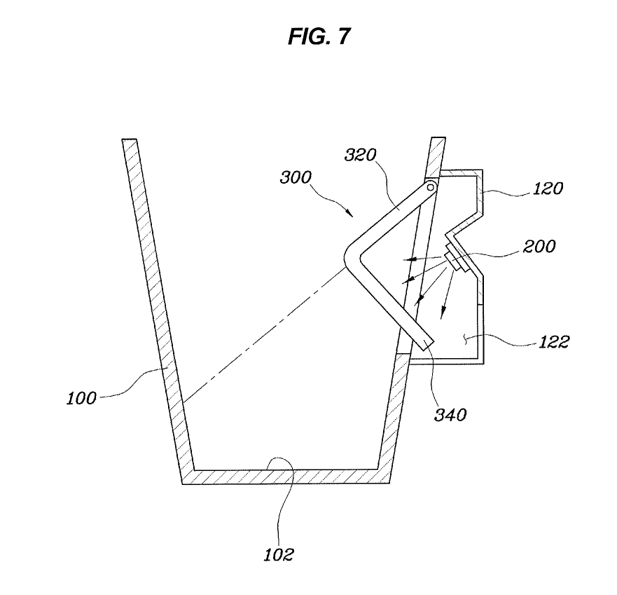

In a cup holder according to a first exemplary embodiment of the present invention as shown in FIG. 7, the supporting mechanism 300 is elastically and rotatably installed in the installing space 120 of the holder body 100 and the lighting apparatus 200 is installed in the installing space 120 so as to irradiate the bottom surface 102 of the holder body 100 from the installing space 120.

Here, the upper surface portion 320 of the supporting mechanism 300 is opaquely or semi-transparently formed to transmit light which is refracted or scattered, and the lower surface portion 340 is transparently formed to transmit light as it is, such that light emitted from the lighting apparatus 200 is not transmitted or directed to the upper surface of the holder body 100 as it is, thereby making it possible to prevent the user's dazzle from being generated.

Various embodiments of the present invention may be readily adjustable to have other configurations and shapes.

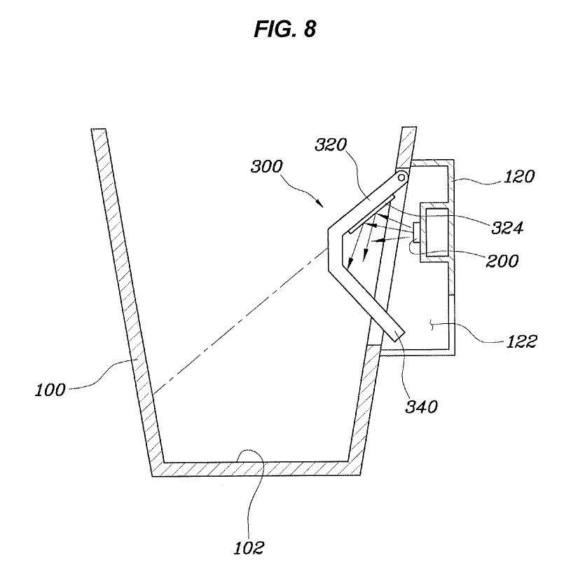

Meanwhile, in a cup holder according to a second exemplary embodiment of the present invention as shown in FIG. 8, the upper surface portion 320 of the supporting mechanism 300 may be provided with a light reflecting unit 324 allowing light irradiated from the light apparatus to be reflected from an end surface facing the lighting apparatus 200, wherein the light reflecting unit 324 may be installed so as to allow the reflected light to direct toward the bottom surface 102 of the holder body 100.

This is to prevent light emitted from the lighting apparatus 200 from transmitting through the upper surface portion 320 by providing the light reflecting unit 324 reflecting light that impinges on the upper surface portion 320 of the supporting mechanism 300 and reflect light emitted from the lighting apparatus 200 by the light reflecting unit 324 provided to the upper surface portion 320 of the supporting mechanism to thereby irradiate the reflected light toward the bottom of the holder body.

As such, light impinged on the upper surface portion 320 of the supporting mechanism 300 is blocked or completely blocked using the light reflecting unit 324 and light is intensively irradiated to the bottom surface 102 of the holder body 100, thereby making it possible to concentrate on effect of the indirect lighting.

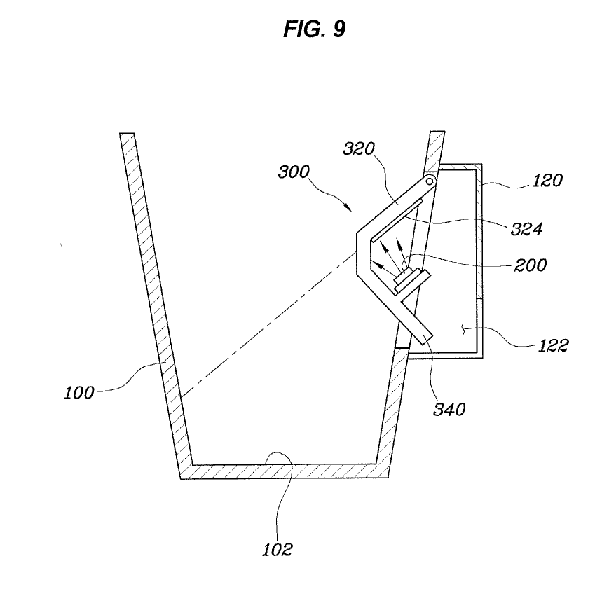

Meanwhile, in a cup holder according to a third exemplary embodiment of the present invention as shown in FIG. 9, the lower surface portion 340 of the supporting mechanism 300 is provided with the lighting apparatus 200 installed on an end surface of the installing space 120 side of the holder body 100, wherein the lighting apparatus 200 may be installed so as to allow a light to be directed toward the light reflecting unit 324 provided on the upper surface portion 320.

Similar to the second exemplary embodiment of the present invention, this is to block light transmitted to the upper surface portion 320 of the supporting mechanism 300 using the light reflecting unit 324 and concentrate the light on the bottom surface 102 of the holder body 100.

In the case of the third exemplary embodiment of the present invention, however, the lighting apparatus 200 irradiating light toward the light reflecting unit 324 is installed at the lower surface portion 340 of the supporting mechanism 300, such that the lighting apparatus 200 is rotated together with the supporting mechanism 300 which is rotated when the beverage container A is received in the holder body 100.

That is, light emitted from the lighting apparatus 200 installed at the lower surface portion 340 of the supporting mechanism 300 may be irradiated only to the light reflecting unit 324 provided on the upper surface portion 320 and light reflected by the light reflecting unit 324 may be irradiated to the bottom surface 102 of the holder body 100.

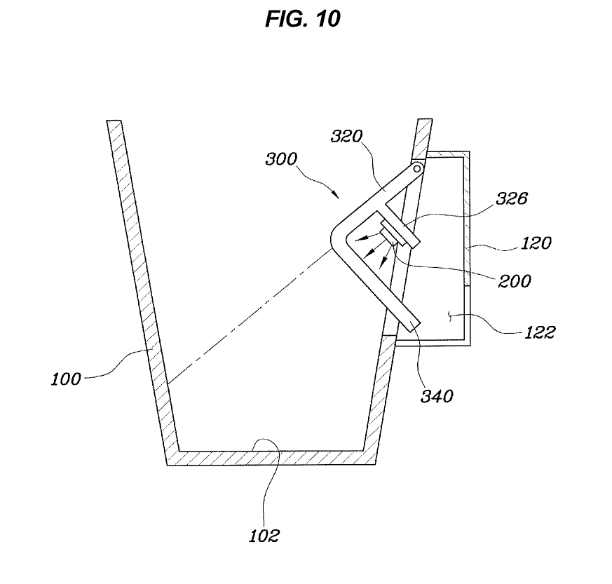

In a cup holder according to a fourth exemplary embodiment of the present invention as shown in FIG. 10, the upper surface portion 320 of the supporting mechanism 300 may be provided with an installing part 326 so as to be extended to the installing space 120 and the lighting apparatus 200 may be installed on the installing part 326 so as to irradiate the bottom surface 102 of the holder body 100.

This is to rotate the lighting apparatus 200 together with the supporting mechanism 300 which is rotated when the beverage container A is received in the holder body 100, by forming the installing part 326 on the upper surface portion 320 of the supporting mechanism 300 and installing the lighting apparatus 200 on the installing part 326. By the configuration as described above, even though the supporting mechanism 300 is rotated by the beverage container A, light may be intensively irradiated on the bottom surface 102 of the holder body 100.

According to various embodiments of the present invention, the cup holder may allow the user to easily detect the position of the cup holder by light emitting using the lighting apparatus in the case of night at which it is difficult to secure visibility.

Particularly, according to various embodiments of the present invention, the lighting apparatus is installed within the supporting mechanism grasping the beverage container received in the cup holder and the apparatus irradiates the bottom of the cup holder, such that light is not directly delivered to the driver and reflected light is delivered to the driver, thereby making it possible to prevent the generation of dazzle.

Further, when the beverage container is received in the cup holder, the lighting apparatus irradiates the side of the beverage container to thereby allow light reflected from the beverage container to be irradiated to the outside, such that lighting effect is changed depending on the reception of the beverage container, thereby making it possible to improve luxuriousness.

For convenience in explanation and accurate definition in the appended claims, the terms “upper” or “lower”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cup holder, comprising:
a holder body formed in a cylindrical shape, having an opened upper surface and having an installing space formed on an inner peripheral surface of the holder body and protruded from an inner side to an outer side;
a lighting apparatus provided in the installing space of the holder body to thereby irradiate light toward an interior of the holder body; and
a supporting mechanism elastically and rotatably installed in the installing space of the holder body to thereby support a beverage container received in the holder body and allowing light irradiated from the lighting apparatus to be directed to a bottom surface of the holder body.

2. The cup holder of claim 1, wherein the supporting mechanism is formed to be rotatably installed at an upper end of the installing space of the holder body, inclined downwardly and extended from the upper end of the installing space to the interior of the holder body, and then bent and extended to a lower end of the installing space.

3. The cup holder of claim 2, wherein the supporting mechanism includes an upper surface portion that refracts and/or scatters the light irradiated from the lighting apparatus and a lower surface portion that transmits the light irradiated from the lighting apparatus.

4. The cup holder of claim 3, wherein the upper surface portion of the supporting mechanism is opaque or semi-transparent, and the lower surface portion is transparent and has higher transmissivity of light than the upper surface portion.

5. The cup holder of claim 3, wherein the upper surface portion of the supporting mechanism is provided with embossed patterns to thereby scatter the light.

6. The cup holder of claim 3, wherein the upper surface portion of the supporting mechanism is provided with a light reflecting unit disposed on an end surface facing the lighting apparatus to reflect the light irradiated from the light apparatus and direct the reflected light toward the bottom surface of the holder body.

7. The cup holder of claim 6, wherein the lower surface portion of the supporting mechanism is provided with the lighting apparatus installed on an end surface of an installing space side of the holder body and the lighting apparatus is installed to irradiate the light and direct the irradiated light toward the light reflecting unit provided on the upper surface portion.

8. The cup holder of claim 3, wherein the upper surface portion of the supporting mechanism is provided with an installing part extended to an installing space side of the holder body and the lighting apparatus is installed on the installing part to irradiate the light to the bottom surface of the holder body.

9. The cup holder of claim 1, wherein a plurality of supporting mechanisms are formed at a circumference of the inner peripheral surface of the holder body.

10. The cup holder of claim 1, wherein the lighting apparatus includes a light emitting diode (LED) lamp capable of emitting light in different colors.

11. The cup holder of claim 1, wherein the installing space of the holder body is provided with a ventilation opening to dissipate heat generated by the lighting apparatus.
